(19) United States
(12) Patent Application Publication
(10) Pub. No.: US 2006/0235149 A1
(43) Pub. Date: Oct. 19, 2006

(54) Crystallizable pinene-based tackifiers for temperature switchable adhesives

(76) Inventor: Robert Ray Burch, Exton, PA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/107,132

(22) Filed: Apr. 15, 2005

(51) Int. Cl. C08L 53/00

(52) U.S. Cl. 525/88; 525/191

(57) ABSTRACT

Pinene copolymers which function as crystallizable tackifiers are described. Also described are temperature switchable pressure sensitive adhesives comprising an elastomer and a crystallizable pinene-based tackifier. These pressure sensitive adhesives exhibit a sharp reduction in peel strength when the temperature is raised above the switching temperature. The adhesive properties of these adhesives may be readily tuned by adjusting the ratio of the elastomer and the crystallizable tackifier, and by altering the crystallizable group on the tackifier. The temperature switchable pressure sensitive adhesives have use in medical, consumer, and industrial applications.

### FIELD OF THE INVENTION

The invention relates to the field of pressure sensitive adhesives. More specifically, the invention relates to crystallizable pinene-based tackifiers and temperature switchable pressure sensitive adhesive compositions comprising them.

### BACKGROUND OF THE INVENTION

Pressure sensitive adhesives (PSA) are well known and are used in many industrial, consumer and medical applications. Pressure sensitive adhesives are formulations typically comprising an elastomeric polymer, a tackifier, and optionally an oil or other additives. These adhesives remain permanently tacky and adhere instantaneously to a wide variety of surfaces with the application of a small amount of pressure. Pressure sensitive adhesives are generally used in the form of a coating on a backing, such as in adhesive bandages, wound dressings, transdermal delivery devices, tapes, stencils, wall paper, envelopes, stamps, and floor tiles.

For many applications, it is desirable to be able to remove the adhesive from the surface without significant force, so that the surface, for example, newly healed skin, is not damaged. For this reason, switchable adhesives, which undergo a reduction in peel strength with a change in conditions, have been developed. Switchable adhesives that exhibit a reduction in peel strength upon contact with water or exposure to UV radiation are known. Additionally, temperature switchable adhesives, which undergo a reduction in peel strength with a temperature change have also been reported.

Stewart in U.S. Pat. Nos. 5,156,911 and 5,387,450 describes a temperature switchable adhesive composition comprising a side chain crystallizable polymer. The adhesive is nontacky, or slightly tacky at room temperature, but is aggressively tacky at skin temperature. Therefore, the adhesive may be removed from the skin by cooling.

Schmitt et al. in U.S. Pat. No. 5,412,035 describe pressure sensitive adhesive compositions, containing a crystalline polymeric additive, that lose adhesive strength upon heating. The crystalline polymeric additive is preferably a side chain crystallizable polymer having a weight average molecular weight of less than 25,000.

The aforementioned temperature switchable adhesives provide the desirable property of losing adhesive strength with a change in temperature. However, it is difficult to adjust the temperature switchable properties of those adhesive compositions because a different crystallizable side chain polymer and monomer must be synthesized to meet different switching temperature requirements.

Oligomeric α-pinene is a commonly used tackifier in pressure sensitive adhesive compositions. However, pinene copolymers having crystallizable groups and their use as crystallizable tackifiers in temperature switchable pressure sensitive adhesives have not been reported.

In view of the above, the need exists for new temperature switchable adhesives for which the temperature switching properties may be readily adjusted to meet the requirements for many different applications by readily changing the tackifier and elastomer used in the formulation, according to standard principles of adhesive formulation.

Applicants have addressed the stated need by discovering that certain pinene copolymers having crystallizable groups may be used as a tackifier to give new temperature switchable pressure sensitive adhesive compositions. The adhesive properties of these adhesives may be readily tuned to meet the requirements of various applications.

### SUMMARY OF THE INVENTION

The invention provides pinene copolymers that function as crystallizable tackifiers. The invention also provides temperature switchable pressure sensitive adhesives comprising an elastomer and a crystallizable pinene-based tackifier. These pressure sensitive adhesives exhibit a sharp reduction in peel strength when the temperature is raised above the switching temperature. Accordingly, in one embodiment the invention provides a copolymer comprising:
a) at least one pinene monomer selected from the group consisting of β-pinene and α-pinene oxide; and
b) at least one comonomer selected from the group consisting of vinyl ethers, alkoxy styrenes, cyclopentadienes, and dicyclopentadienes, having at least one crystallizable group;

wherein:
(i) the crystallizable group is a linear or branched, substituted or unsubstituted alkyl or trans alkenyl group having from 12 to 30 carbon atoms, a fluoroalkyl or trans fluoroalkenyl group having from 12 to 30 carbon atoms, phenyl, benzyl, or naphthalenyl; and
(ii) the copolymer is a random, blocky, or alternating copolymer in which the molar ratio of (a) to (b) is from about 4:1 to about 1:4 and has a number average molecular weight of at least about 400 Daltons.

In another embodiment, the invention provides a composition comprising:
a) at least one elastomer; and
b) at least one copolymer comprising:
   (i) at least one pinene monomer selected from the group consisting of β-pinene and α-pinene oxide; and
   (ii) at least one comonomer selected from the group consisting of vinyl ethers, alkoxy styrenes, cyclopentadienes, and dicyclopentadienes, having at least one crystallizable group;

wherein:
(A) the crystallizable group is a linear or branched, substituted or unsubstituted alkyl or trans alkenyl group having from 12 to 30 carbon atoms, a fluoroalkyl or trans fluoroalkenyl group having from 12 to 30 carbon atoms, phenyl, benzyl, or naphthalenyl;
(B) the copolymer is a random, blocky, or alternating copolymer in which the molar ratio of (a) to (b) is from about 4:1 to about 1:4 and has a number average molecular weight of at least about 400 Daltons; and
(C) the ratio of said elastomer to said copolymer is from about 3:1 to about 1:5 by weight.

In another embodiment, the invention provides a temperature switchable adhesive assembly comprising: a backing and a coating comprising the aforementioned composition.

In another embodiment, the invention provides a method for imparting temperature switchable properties to an elastomer comprising the steps of:
a) providing at least one elastomer; and
b) mixing the at least one elastomer with at least one copolymer comprising:
   (i) at least one pinene monomer selected from the group consisting of β-pinene and α-pinene oxide; and
   (ii) at least one comonomer selected from the group consisting of vinyl ethers, alkoxy styrenes, cyclopentadienes, and dicyclopentadienes, having at least one crystallizable group;

wherein:
(A) the crystallizable group is a linear or branched, substituted or unsubstituted alkyl or trans alkenyl group having from 12 to carbon atoms, a fluoroalkyl or trans fluoroalkenyl group having from 12 to 30 carbon atoms, phenyl, benzyl, or naphthalenyl;
(B) the copolymer is a random, blocky, or alternating copolymer in which the molar ratio of (a) to (b) is from about 4:1 to about 1:4 and has a number average molecular weight of at least about 400 Daltons; and
(C) the ratio of said elastomer to said copolymer is from about 3:1 to about 1:5 by weight.

### DETAILED DESCRIPTION OF THE INVENTION

The invention relates to pinene copolymers that function as crystallizable tackifiers. The invention also provides temperature switchable pressure sensitive adhesives comprising an elastomer and a crystallizable pinene-based tackifier. The adhesive properties of these adhesives may be tuned by simply adjusting the ratio of the elastomer and the crystallizable tackifier, and by altering the crystallizable group on the tackifier. These properties include the switching temperature, the peel strength above and below the switching temperature, and the tack above and below the switching temperature.

The invention is useful because the temperature switchable adhesives of the invention have application in industrial, consumer, and medical fields. For example, the temperature switchable adhesives may be used in medical applications to attach adhesive tape, adhesive bandages, immobilization devices, wound dressings, transdermal delivery devices, EKG electrodes, and the like to skin. These devices may be easily removed, without damage to the skin, by changing the temperature. Additionally, the adhesives may be used in industrial and consumer applications, such as masking tapes, stencils, envelopes, stamps, labels, wallpaper, and floor tiles.

The following definitions are used herein and should be referred to for interpretation of the claims and the specification.

The term “copolymer” refers to a polymer which contains two or more different types of repeat units.

The term “random copolymer” refers to a copolymer in which the different repeat units are arranged randomly along the polymer chain.

The term “blocky copolymer” refers to a copolymer in which the different repeat units occur as long sequences or blocks joined together linearly.

The term “alternating copolymer” refers to a copolymer in which the different repeat units alternate down the polymer chain.

The phrase “temperature switchable adhesive” refers to a pressure sensitive adhesive that exhibits a sharp change in peel strength with a change in temperature.

The term “switching temperature” refers to the temperature at which the temperature switchable adhesives of the invention undergo a sharp change in peel strength. The peel strength is high below the switching temperature and decreases sharply above the switching temperature.

The term “peel strength” refers to the strength of the adhesive bond of an adhesive, measured as the average load per unit width of bond line required to separate bonded materials. Standard laminates of the temperature switchable pressure sensitive adhesives on backing and substrates used for measuring the peel strength are prepared according to ASTM Method D-3330. The 90° peel strength is measured according to IPC Test Method 650.

The term “elastomer” refers to a polymer that recovers completely and very quickly from great extensions, which can be up to 1000% or more. As used herein, elastomers include thermoplastic elastomers and uncrosslinked polyolefins that are thermoplastic.

The term “tackifier” refers to a substance added to resins to improve the initial and extended tack range of the adhesive.

The term “tack” refers to the ability of a material to stick to the surface on momentary contact and then to resist separation.

The term “crystallizable group” refers to a chemical group which undergoes a phase transition, specifically crystallization/melting.

The term “crystallizable tackifier” refers to a tackifier having at least one crystallizable group.

The phrase “temperature switchable adhesive assembly” refers to a material comprising a backing coated with a temperature switchable pressure sensitive adhesive.

The term “substrate” refers to any surface to which application of the temperature switchable adhesive assembly is desired.

The invention relates to pinene copolymers that function as crystallizable tackifiers. The crystallizable pinene-based tackifiers may be readily synthesized and combined with various elastomeric polymers and optionally, various additives, to give temperature switchable adhesives that meet the requirements of many applications. The adhesives of the invention are generally used in the form of a coating on a backing.

Crystallizable Pinene-Based Tackifiers

The crystallizable pinene-based tackifiers of the invention are copolymers comprising at least one pinene monomer including, but not limited to β-pinene (I) (CAS No. 127-91-3) and α-pinene oxide (II) (CAS No. 74525-43-2) 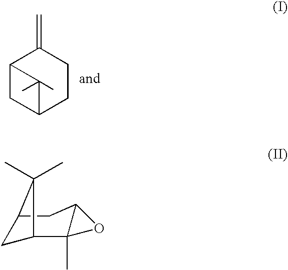
and at least one comonomer that is capable of cationically polymerizing with the pinene monomer and has at least one crystallizable group. A mixture of pinene monomers and comonomers may also be used. Suitable comonomers include vinyl ethers, alkoxy styrenes, cyclopentadienes, and dicyclopentadienes having at least one crystallizable group. Exemplary crystallizable groups include, but are not limited to, linear or branched, substituted or unsubstituted alkyl or trans alkenyl groups having from 12 to 30 carbon atoms, fluoroalkyl or trans fluoroalkenyl groups having from 12 to 30 carbon atoms, phenyl, benzyl and naphthalenyl.

The copolymer may be a random, blocky, or alternating copolymer in which the molar ratio of the pinene monomer to the comonomer having at least one crystallizable group is from about 4:1 to about 1:4 and has a number average molecular weight of at least about 400 Daltons. Preferably, the number average molecular weight is about 800 to about 3000 Daltons. The number average molecular weight of the copolymer may be determined using methods known in the art, for example, gel permeation chromatography, NMR, or mass spectrometry. The copolymer may further comprise one or more additional monomers that are capable of polymerizing cationically, such as for example, styrenes, isoprenes, indenes, acenaphthylenes, vinyl carbazoles, norbornenes, cyclopentadienes and dicyclopentadienes.

In one embodiment, the crystallizable pinene-based tackifier is a copolymer as described above, wherein the pinene monomer is β-pinene and the comonomer is octadecyl vinyl ether.

The crystallizable pinene-based tackifiers of the invention may be prepared from β-pinene or α-pinene oxide and a comonomer having at least one crystallizable group. β-pinene and α-pinene oxide are available commercially from sources such as Sigma-Aldrich (St. Louis, Mo.), PENTA Manufacturing Co. (Livingston, N.J.), Eastman Chemical (Kingsport, Tenn.) and Arizona Chemical (Panama City, Fla.).

Some comonomers having at least one crystallizable group are available commercially. For example, vinyl ethers, such as octadecyl vinyl ether (CAS No. 930-02-9), may be obtained from Sigma-Aldrich, Monomer-Polymer and DAJAC Laboratories, Inc. (Featerville, Pa.), BASF Intermediates (Florham Park, N.J.) and International Specialty Products (Wayne, N.J.). Additionally, vinyl ether monomers may be prepared by a variety of methods known in the art, including, but not limited to, reaction of acetylene with the corresponding alcohol, dehydration of acetals, vinylation of alcohols, and vinyl exchange with vinyl acetate (see for example, F. Barbot and P. Miginiac, Helv. Chim. Acta, 62, 1451 (1979), U.S. Pat. No. 4,057,575, U.S. Pat. No. 4,161,610, JP Kokai 80 02,416 (1980), and M. F. Shostakovskii, B. Ya. Mihantev, V. A. Nemerman, Izv. Akad. Nauk SSR 3, 484 (1952)).

Other comonomers having crystallizable groups may be prepared using methods known in the art. For example, hydroxy styrenes, available from Spectrum Chemicals and Laboratory Products (Gardena, Calif.), Penta Manufacturing Co., E.I. du Pont de Nemours and Co. (Wilmington, Del.), and BASF Corp. (Mount Olive, N.J.); cyclopentadienes, available from Monomer-Polymer and DAJAC Laboratories, Inc., Spectrum Chemicals and Laboratory Products, and Veisicol Chemical Corp. (Chicago, Ill.); and dicyclopentadienes, available from Sigma-Aldrich, Monomer-Polymer and DAJAC Laboratories, Inc., and Spectrum Chemicals and Laboratory Products; may be derivatized to contain crystallizable groups. For example, alkoxy styrene monomers having at least one crystallizable group may be prepared by etherification of hydroxy styrene using a long chain alkyl halide or other long chain alkyl ether precursor. Additionally, the etherification reaction may be done with the halide form of the other aforementioned crystallizable groups.

Cyclopentadienes and dicyclopentadienes having at least one crystallizable group may be prepared by reaction with base, followed by reaction with the crystallizable group in the form of an alkylating group, such as an alkyl bromide.

The monomers may be purified before use using methods known in the art, for example, distillation.

The crystallizable pinene-based tackifiers of the invention may be prepared by cationic polymerization of the pinene monomer and the comonomer having at least one crystallizable group. Cationic polymerization is well known in the art (for example see Carbocationic Polymerization, J. P. Kennedy and E. Marechal, Wiley Interscience, New York, 1982). For example, the polymerization may be done at low temperature in solution using a mixture of aluminum trichloride and antimony trichloride, as described in Example 1. Alternatively, the pinene monomer and the comonomer having at least one crystallizable group may be copolymerized in the presence of a variety of Lewis acids or Bronsted acids, such as anhydrous methane sulfonic acid, anhydrous trifluoromethane sulfonic acid, benzene sulfonic acid, toluene sulfonic acid, boron trifluoride, boron trifluoride etherate, other halides or antimony and aluminum, hydrogen iodide/iodine, and sulfur dioxide. In general, these acids should be water-free, although trace amounts of water may be beneficial for some of these cationic polymerizations (J. P. Kennedy and E. Marechal, above).

Temperature Switchable Pressure Sensitive Adhesives

The temperature switchable pressure sensitive adhesives of the invention comprise an elastomer and a crystallizable pinene-based tackifier. Mixtures of two or more elastomers and/or two or more crystallizable pinene-based tackifiers may also be used. The temperature switchable adhesives of the invention have temperature switchable adhesion and temperature switchable tack. The adhesion is high below the switching temperature and decreases sharply above the switching temperature. In contrast, the tack is low below the switching temperature and increases sharply above the switching temperature.

Any suitable elastomer known in the pressure sensitive adhesive art may be useful in the invention, including, but not limited to, thermoplastic rubbers, natural rubbers, butyl rubbers, polyisobutylene polymers, vinyl ether polymers, ethylene/acrylic copolymers, and silicone-based rubbers. Preferably, the elastomer is a thermoplastic rubber of the ABA block copolymer type, wherein A is a thermoplastic polystyrene end block and B is a rubber mid-block, such as polyisoprene, polybutadiene, and poly(ethylene/butylene). Typically, the elastomer has a thermoplastic polystyrene end-block content of about 14% to about 30% by weight of the block copolymer. Suitable elastomers are well known in the art of pressure sensitive adhesives and are available from commercial sources, such as Sigma-Aldrich, and the Dow Chemical Co. (Midland, Mich.).

In one embodiment, the elastomer is a styrene-isoprene-styrene triblock copolymer which has a styrene content of about 14% to about 22% by weight. In another embodiment, the elastomer is a styrene-isoprene-styrene triblock copolymer which has a styrene content of about 22% by weight.

The adhesive properties of the temperature switchable pressure sensitive adhesives of the invention may be tuned for different applications. For example, the switching temperature may be tuned coarsely by changing the comonomer. For example, the copolymer of β-pinene and octadecyl vinyl ether has a higher switching temperature than the copolymer of β-pinene and hexadecyl vinyl ether. Other properties of the temperature switchable pressure sensitive adhesives may be adjusted by changes in formulation, as is well known in the art. For example, tack may be increased at the expense of peel strength by increasing the ratio of tackifier to elastomer. In the temperature switchable pressure sensitive adhesives of the invention, the elastomer and the crystallizable pinene-based tackifier are typically used in a ratio from about 3:1 to about 1:5 by weight. In one embodiment, the ratio of elastomer to crystallizable pinene-based tackifier is 1:3 by weight. Cohesive strength (i.e., the strength of the forces that hold adjacent molecules together within the adhesive) may be improved by increasing the molecular weight of the elastomer, at the expense of ease of processing. The cohesive properties of the temperature switchable pressure sensitive adhesive may likewise be improved by means of cross-linking the elastomeric component. These principles of formulation are well understood by those skilled in the art of pressure sensitive adhesives.

The temperature switchable pressure sensitive adhesives of the invention may optionally comprise one or more additives, which are known in the art. Examples of suitable additives include, but are not limited to, oils, inorganic extenders, stabilizers, antioxidants, plasticizers, flow modifiers, dyes, pigments, other tackifiers, heat reactive curing compounds, light reactive curing compounds, and wetting agents. These additives may be incorporated into the temperature switchable pressure sensitive adhesives of the invention in minor or larger amounts, depending on the intended use of the adhesive.

The temperature switchable pressure sensitive adhesives may be prepared using techniques known in the art. For example, the elastomer, the crystallizable tackifier, and the optional additives may be dissolved in a suitable solvent and applied to a backing, with subsequent removal of the solvent, as described below. Alternatively, the aforementioned ingredients may be blended in the melt using a high shear mixer or an extruder.

Temperature Switchable Adhesive Assemblies

The temperature switchable pressure sensitive adhesives of the invention are generally used as a coating on a backing to form a temperature switchable adhesive assembly. Any appropriate backing may be used, including, but not limited to, tapes, films or sheets of synthetic or natural polymers, woven or nonwoven fabrics, and paper products, such as labels, paper tapes, envelopes, stamps, and cardboard. The backing should maintain structural integrity at the temperature of application to the desired surface and at the elevated temperature required to release the assembly from the surface. The backing may be coated with the temperature switchable pressure sensitive adhesive in various ways, including, but not limited to, spraying, painting, dipping, gravure printing, rolling, laminating, and the like. The adhesive composition may also be applied by transfer from a release sheet. For example, coating technologies widely practiced in the pressure sensitive adhesive art may be employed for laminating these temperature switchable adhesives to backings and release paper (see for example, Handbook of Pressure-Sensitive Adhesive Technology, D. Satas, ed, Van Nostrand Reinhold, New York, N.Y., 1982). These coating technologies include, but are not limited to, knife-over-roll, trailing blade, wire-wound rod, air doctor, reverse roll, gravure roll, and slot orifice. The composition may be applied neat, or in a suitable solvent, or as an emulsion or a latex.

The thickness of the adhesive layer will vary depending on the intended application. Typically, the thickness of the adhesive layer is about 0.5 mils (0.0127 mm) to about 25 mils (0.76 mm). The appropriate adhesive layer thickness for any particular application may be readily determined using routine experimentation by one skilled in the art.

The temperature switchable adhesive assemblies of the invention may also comprise a release paper or release film to cover the adhesive layer prior to application to the desired surface, as is known in the art.

The temperature switchable adhesive assemblies of the invention may be used for a variety of medical applications in the form of adhesive tapes, adhesive bandages, immobilization devices, wound dressings, transdermal delivery devices, EKG electrodes, and the like. Additionally, the assemblies may be used for industrial and consumer applications, such as masking tapes, stencils, envelopes, stamps, labels, wallpaper, and floor tiles.

The temperature switchable adhesive assembly is attached to the desired substrate by applying it to the surface with a small amount of pressure. Because the temperature switchable adhesives of the invention have temperature switchable tack that changes in the opposite direction as the adhesive strength, the assembly is applied to the desired substrate at a temperature above the switching temperature to form the bond and then is cooled to a temperature below the switching temperature to maintain the bond. The assembly is left in place for as long as desired and then is removed by increasing the temperature to the point where the adhesive properties are significantly diminished. The temperature may be increased using any suitable means depending on the application. For example, a warm compress, a chemical heat pack, a heating pad, or warm water may be used for medical applications, while a hair dryer, a hot air gun, an oven, a warming chamber, or ambient heat may be used for industrial and consumer applications.

In another embodiment, the invention provides a method for imparting temperature switchable properties to an elastomer comprising mixing the elastomer with a crystallizable pinene-based tackifier, using the methods described above.

### EXAMPLES

The present invention is further defined in the following Examples. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various uses and conditions.

The meaning of abbreviations used is as follows: “min” means minute(s), “h” means hour(s), “sec” means second(s), “mL” means milliliter(s), “μL” means microliter(s), “cm” means centimeter(s), “mm” means millimeter(s), “μm” means micrometer(s), “mils” means thousandths of an inch, “g” means gram(s), “mg” means milligram(s), “kg” means kilogram(s), “lb” means pound(s), “wt %” means percent by weight, “PVC” means poly(vinyl chloride), “J” means joule(s), “Tₘ” means melting temperature, “T_{g}” means glass transition temperature, and “T_{c}” means the crystallization temperature.

General Methods:

Reagents and Solvents:

The triblock copolymer, polystyrene-block-polyisoprene-block-polystyrene, referred to hereafter as “PSIS”, (CAS No. 25038-32-8, 22 wt % styrene, melt index 3 g/10 min, viscosity 12 poise (25 wt % in toluene, 25° C., Brookfield)), poly-β-pinene, poly-α-pinene, and the monomers α-pinene, β-pinene, and octadecyl vinyl ether were obtained from Sigma-Aldrich (St. Louis, Mo.). Solvents were distilled according to standard solvent purification procedures. Aluminum chloride and antimony(III) chloride were purchased from Sigma-Aldrich and used as received.

### Example 1

### Preparation of Octadecyl Vinyl Ether Copolymer with β-Pinene

The purpose of this Example was to prepare the copolymer of octadecyl vinyl ether with β-pinene using a 2.2 to 1 mole ratio of β-pinene to octadecyl vinyl ether. The copolymer was prepared by cationic polymerization of β-pinene and octadecyl vinyl ether at low temperature in solution using a mixture of aluminum trichloride and antimony trichloride

A solution containing 5.0 g of β-pinene and 5.0 g of octadecyl vinyl ether (distilled prior to use) in 8.3 mL of toluene was prepared and placed in a nitrogen-flushed reaction flask connected to a dry nitrogen source and bubbler. Separately, a nitrogen-blanketed 100 mL three-neck flask was charged with 7.63 g of toluene (8.8 mL) and then with 0.3 g of aluminum chloride, followed by 0.0934 g of antimony trichloride. The resulting mixture was vigorously stirred while cooling the reaction flask to −20° C. The solution containing the monomers was then introduced into the reaction flask over a period of 20 min. The temperature was maintained at −20° C. by means of a xylenes/dry ice cooling bath. Thereafter, the contents of the flask were maintained in a nitrogen atmosphere at this temperature. The reaction mixture froze after 5 min. At this point, the temperature was allowed to rise gradually to 0° C. over the course of 10 min with controlled cooling. Finally, the temperature was allowed to slowly rise to room temperature over the course of 90 min. Then, water, equal in volume to the octadecyl vinyl ether and β-pinene solution used, was added to inactivate the catalyst system and to cause separation of the aqueous and organic phases. Following filtration to remove the insoluble components, the remaining phases were separated, and the organic phase was washed once with 5% sodium bicarbonate, followed by a water rinse until the pH was neutral. The solvent was then removed by vacuum evaporation. A yellow product (8.9 g) was obtained.

The product was analyzed using proton NMR, gel permeation chromatography (GPC), and differential scanning calorimetry. NMR revealed that the copolymer contained 40 mole % octadecyl vinyl ether. GPC gave a number-average molecular weight (Mₙ) of 1534, and a weight-average molecular weight (M_{w}) of 5892. Differential scanning calorimetry showed a T_{g} at about −25° C. (indicated by a change in heat capacity), three Tₘ's at 28.6° C., 34° C., and 43° C. (indicated as endotherms), with a total area of 44 J/g, in the first heat. The cooling curve showed a T_{c} at 24.7° C. (35 J/g) (indicated as an exotherm), with a T_{g} of −36° C. The second heat shows a T_{g} of −20° C. and a Tₘ at 34° C. (40.3 J/g).

Attempts to prepare a copolymer of octadecyl vinyl ether with a-pinene using similar reaction conditions were not successful. However, the aforementioned synthesis is expected to be applicable to a-pinene oxide.

### Example 2

### Preparation of Octadecyl Vinyl Ether Copolymer with β-Pinene

The purpose of this Example was to prepare the copolymer of octadecyl vinyl ether with β-pinene using a 4.4 to 1 mole ratio of β-pinene to octadecyl vinyl ether.

The procedure used was the same as described in Example 1, except that the solution of the monomers contained 10.0 g of β-pinene and 5.0 g of octadecyl vinyl ether (distilled prior to use) in 8.3 mL of toluene. Proton NMR showed that the product contained 21 mole % of the octadecyl vinyl ether in a structure with a high degree of randomness.

### Examples 3-5

### Temperature Switchable Pressure Sensitive Adhesive

The purpose of these Examples was to prepare a temperature switchable pressure sensitive adhesive using the octadecyl vinyl ether/β-pinene copolymer from Example 1, and to compare its temperature switchable adhesive properties to that of PSIS/poly-β-pinene and PSIS/poly-octadecyl vinyl ether.

Temperature Switchable Peel Strength:

A toluene solution of poly-styrene-isoprene-styrene triblock copolymer was prepared. To this solution, the octadecyl vinyl ether/β-pinene copolymer from Example 1, was added to give a 1 to 3 weight ratio of the triblock copolymer to the octadecyl vinyl ether/β-pinene copolymer. This solution was cast as a film on siliconized release paper using a doctors blade at 30 mil (0.762 mm) thickness. The solvent was then removed at 70° C. in a vacuum oven, to leave a polymer film on the release paper. PVC film was then applied to the polymer film on the release paper at 70° C. and was smoothed by means of a wallpaper seam roller. The film was then allowed to cool to room temperature. The siliconized release paper was then removed and the film was then applied to a PVC-faced cloth (96.5 μm thickness), textured to be a leather look-alike (obtained from a local fabric store), according to ASTM method D-3330, at 65° C. For creating the adhesive bonds, an aluminum metal plate was used which was heated by a hotplate. The temperature of the metal plate was maintained by manual temperature adjustment using a thermocouple to monitor the temperature (the “set temperature”). A 2.5 lb (1.13 kg) metal wallpaper seam roller, attached to an Instron® device with a cross-head speed of 12 inches/min (30.5 cm/min), was used to laminate the bond by rolling it back and forth across the sample.

The samples were maintained at the set temperature in a temperature controlled oven until the samples were ready for measuring the temperature dependence of the 90° peel strength. The peel strength measurements were done according to IPC Test Method 650, using an Instron® device equipped with a temperature-controlled oven and a metal wheel. The sample was mounted on the wheel using double-faced Kapton® adhesive tape on the edge of the roller and metal adhesive tape to hold down the ends. The sample sizes were typically 1 inch×3 inches (2.5 cm×7.6 cm) or 0.5 inch×3 inches (1.3 cm×7.6 cm). The clamps on the Instron® device were attached to the free end of the backing material. The samples were pulled at 6 inches/min (15.2 cm/min), and the data was recorded and processed using MTS Test Works 4 system, purchased from the MTS Systems Corp. (Eden Prairie, Minn.) for software test control and data acquisition. Load and displacement were captured through an analog to digital card and the average calculated by integration through selected points on the curve. The peel strength as a function of temperature was then determined, allowing a 2 min equilibration time for the samples at each temperature. The peel strengths at different temperatures, given as the average and standard deviation measured along the length of the sample, are shown in Table 1.

Similarly, pressure sensitive adhesives, consisting of PSIS/poly-β-pinene (1:3 weight ratio) and PSIS/poly-octadecyl vinyl ether (1:3 weight ratio) were prepared and tested as described above. The results are also given in Table 1.

The results demonstrate that the PSIS/poly-octadecyl vinyl ether/β-pinene copolymer, (Example 3) had a sharp decrease in peel strength between temperatures of 18° C. and 31° C., demonstrating the temperature switchable property of the adhesive. The PSIS/poly-β-pinene pressure sensitive adhesive (Example 4) did not demonstrate temperature switchable adhesive properties. The blend of PSIS with poly-octadecyl vinyl ether (Example 5) did not function as a pressure sensitive adhesive because it had very low peel strengths, and it had no temperature switchable properties.

TABLE 1
Peel Strengths of Pressure Sensitive Adhesives as a Function of
Temperature

| | | Temperature | Peel strength |
|---|---|---|---|
| Example | Sample | ° C. | g/mm |
| Example 3 | PSIS/poly- | 18 | 25.86 ± 7.51 |
| | octadecyl vinyl | 23 | 8.99 ± 5.83 |
| | ether/β-pinene | 27 | 3.84 ± 0.77 |
| | copolymer | 31 | 0.97 ± 0.45 |
| | | 37 | 1.59 ± 0.23 |
| Example 4, | PSIS/poly-β- | 18 | 23.1 ± 12.08 |
| Comparative | pinene | 23 | 4.41 ± 2.00 |
| | | 27 | 16.83 ± 10.00 |
| | | 31 | 26.02 ± 9.65 |
| | | 37 | 32.24 ± 9.29 |
| Example 5, | PSIS/poly- | 18 | 1.22 ± 0.20 |
| Comparative | octadecyl vinyl | 23 | 0.00 ± 0.00 |
| | ether | 31 | 1.36 ± 0.27 |
| | | 37 | 0.89 ± 0.34 |
| | | 55 | 1.07 ± 0.23 |

Temperature Switchable Tack:

The styrene-isoprene-styrene triblock copolymer (CAS No. 25038-32-8, 22 wt % styrene, melt index 3 g/10 min, viscosity 12 poise) and the copolymer of β-pinene and octadecyl vinyl ether (prepared as described in Example 1) were dissolved in toluene to give a solution with 25 wt % solids and a 1:3 weight ratio of styrene-isoprene-styrene triblock copolymer to the copolymer of β-pinene and octadecyl vinyl ether. This solution was cast onto a PVC film backing using a doctor blade and dried in a vacuum oven using the method described above. The coated PVC film was then mounted on a glass slide by means of adhesive tape and the film was equilibrated at the desired temperature. The tack as a function of temperature was assessed by means of a finger pressure test according to the following scale: (−) no detectable tack, (+) application of momentary finger pressure caused sufficient bonding to begin to lift the microscope slide off the lab bench, (++) application of momentary finger pressure caused sufficient bonding to lift the microscope slide off the lab bench, with the slide quickly debonding just from the force of gravity, (+++) application of momentary finger pressure caused sufficient bonding to lift the microscope slide off the lab bench, with the slide slowly debonding (greater than 10 sec) under the force of gravity, (++++) application of momentary finger pressure caused sufficient bonding to lift the microscope slide off the lab bench and not debond under the force of gravity. The results are summarized in Table 2.

TABLE 2
Tack of the Temperature Switchable Adhesive
as a Function of Temperature

| Temperature, ° C. | Tack Assessment |
|---|---|
| 4 | + |
| 23 | + |
| 37 | +++ |
| 45 | +++ |

These results demonstrate that the tack of the temperature switchable adhesive increases as the temperature is raised above the switching temperature.

What is claimed is:

1. A copolymer comprising:
a) at least one pinene monomer selected from the group consisting of β-pinene and α-pinene oxide; and
b) at least one comonomer selected from the group consisting of vinyl ethers, alkoxy styrenes, cyclopentadienes, and dicyclopentadienes, having at least one crystallizable group;
wherein:
(i) the crystallizable group is a linear or branched, substituted or unsubstituted alkyl or trans alkenyl group having from 12 to 30 carbon atoms, a fluoroalkyl or trans fluoroalkenyl group having from 12 to 30 carbon atoms, phenyl, benzyl, or naphthalenyl; and
(ii) the copolymer is a random, blocky, or alternating copolymer in which the molar ratio of (a) to (b) is from about 4:1 to about 1:4 and has a number average molecular weight of at least about 400 Daltons.

2. The copolymer according to claim 1 wherein the pinene monomer is β-pinene and the comonomer is octadecyl vinyl ether.

3. The copolymer according to claim 1 wherein the number average molecular weight is about 800 to about 3000 Daltons.

4. The copolymer according to claim 1 further comprising at least one additional comonomer that is capable of cationic polymerization.

5. The copolymer according to claim 4 wherein the at least one additional comonomer is selected from the group consisting of styrenes, isoprenes, indenes, acenaphthylenes, vinyl carbazoles, norbornenes, cyclopentadienes and dicyclopentadienes.

6. A composition comprising:
a) at least one elastomer; and
b) at least one copolymer comprising:
(i) at least one pinene monomer selected from the group consisting of β-pinene and α-pinene oxide; and
(iii) at least one comonomer selected from the group consisting of vinyl ethers, alkoxy styrenes, cyclopentadienes, and dicyclopentadienes, having at least one crystallizable group;
wherein:
(A) the crystallizable group is a linear or branched, substituted or unsubstituted alkyl or trans alkenyl group having from 12 to 30 carbon atoms, a fluoroalkyl or trans fluoroalkenyl group having from 12 to 30 carbon atoms, phenyl, benzyl, or naphthalenyl;
(B) the copolymer is a random, blocky, or alternating copolymer in which the molar ratio of (a) to (b) is from about 4:1 to about 1:4 and has a number average molecular weight of at least about 400 Daltons; and
(C) the ratio of said elastomer to said copolymer is from about 3:1 to about 1:5 by weight.

7. The composition according to claim 6 wherein the pinene monomer is β-pinene and the comonomer is octadecyl vinyl ether.

8. The composition according to claim 6 wherein the at least one copolymer has a number average molecular weight of about 800 to about 3000 Daltons.

9. The composition according to claim 6 wherein the ratio of elastomer to copolymer is 1:3 by weight.

10. The composition according to claim 6 wherein the elastomer is an ABA block copolymer, wherein
a) A is a thermoplastic polystyrene end-block; and
b) B is a rubber mid-block selected from the group consisting of polyisoprene, polybutadiene, and poly(ethylene/butylene);
wherein the elastomer has a thermoplastic polystyrene end-block content of about 14% to about 30% by weight.

11. The composition according to claim 10 wherein the ABA block copolymer is a styrene-isoprene-styrene triblock copolymer having a styrene content of about 14% to about 22% by weight.

12. The composition according to claim 10 wherein the ABA block copolymer is a styrene-isoprene-styrene triblock copolymer having a styrene content of about 22% by weight.

13. The composition according to claim 6 wherein the at least one copolymer further comprises at least one additional comonomer that is capable of cationic polymerization.

14. The composition according to claim 13 wherein the at least one additional comonomer is selected from the group consisting of styrenes, isoprenes, indenes, acenaphthylenes, vinyl carbazoles, norbornenes, cyclopentadienes and dicyclopentadienes.

15. The composition according to claim 6 further comprising one or more additives selected from the group consisting of: oils, inorganic extenders, stabilizers, antioxidants, plasticizers, flow modifiers, dyes, pigments, other tackifiers, heat reactive curing compounds, light reactive curing compounds, and wetting agents.

16. A temperature switchable adhesive assembly comprising:
a) a backing; and
b) a coating comprising the composition of claim 6.

17. A temperature switchable adhesive assembly according to claim 16 wherein the backing is selected from the group consisting of:
tapes, films of synthetic polymers, films of natural polymers, sheets of synthetic polymers, sheets of natural polymers, woven fabrics, nonwoven fabrics, and paper products.

18. The temperature switchable adhesive assembly according to claim 16 wherein the coating has a thickness of about 0.0127 mm to about 0.76 mm.

19. The temperature switchable adhesive assembly according to claim 16, wherein the assembly has a form selected from the group consisting of adhesive tapes, adhesive bandages, immobilization devices, wound dressings, transdermal delivery devices, EKG electrodes, masking tapes, stencils, envelopes, labels, stamps, wall paper, and floor tiles.

20. A method for imparting temperature switchable properties to an elastomer comprising the steps of:
a) providing at least one elastomer; and
b) mixing the at least one elastomer with at least one copolymer comprising:
(i) at least one pinene monomer selected from the group consisting of β-pinene and α-pinene oxide; and
(ii) at least one comonomer selected from the group consisting of vinyl ethers, alkoxy styrenes, cyclopentadienes, and dicyclopentadienes, having at least one crystallizable group;
wherein:
(A) the crystallizable group is a linear or branched, substituted or unsubstituted alkyl or trans alkenyl group having from 12 to 30 carbon atoms, a fluoroalkyl or trans fluoroalkenyl group having from 12 to 30 carbon atoms, phenyl, benzyl, or naphthalenyl;
(B) the copolymer is a random, blocky, or alternating copolymer in which the molar ratio of (a) to (b) is from about 4:1 to about 1:4 and has a number average molecular weight of at least about 400 Daltons; and
(C) the ratio of said elastomer to said copolymer is from about 3:1 to about 1:5 by weight.

21. The method according to claim 20 wherein the pinene monomer is β-pinene and the comonomer is octadecyl vinyl ether.

22. The method according to claim 20 wherein the ratio of elastomer to copolymer is 1:3 by weight.

23. The method according to claim 20 wherein the at least one copolymer has a number average molecular weight of about 800 to about 3000 Daltons.

24. The method according to claim 20 wherein the elastomer is an ABA block copolymer, wherein
a) A is a thermoplastic polystyrene end-block; and
b) B is a rubber mid-block selected from the group consisting of polyisoprene, polybutadiene, and poly(ethylene/butylene);
wherein the elastomer has a thermoplastic polystyrene end-block content of about 14% to about 30% by weight.

25. The method according to claim 24 wherein the ABA block copolymer is a styrene-isoprene-styrene triblock copolymer having a styrene content of about 14% to about 22% by weight.

26. The method according to claim 24 wherein the ABA block copolymer is a styrene-isoprene-styrene triblock copolymer having a styrene content of about 22% by weight.

27. The method according to claim 20 wherein the at least one copolymer further comprises at least one additional comonomer that is capable of cationic polymerization.

28. The method according to claim 20 wherein the at least one additional comonomer is selected from the group consisting of styrenes, isoprenes, indenes, acenaphthylenes, vinyl carbazoles, norbornenes, cyclopentadienes and dicyclopentadienes.
